(19) United States
(12) Patent Application Publication
(10) Pub. No.: US 2015/0344277 A1
(43) Pub. Date: Dec. 3, 2015

(54) LIFT-TRUCK FORK FOR WEIGHING, HAVING REINFORCED AND STIFFENED COVER-ASSEMBLY

(71) Applicant: WEIGH POINT INCORPOATED, Cambridge, (CA)

(72) Inventor: Gerald Sidney SIMONS, North York (CA)

(73) Assignee: WEIGH POINT INCORPORATED, Cambridge (CA)

(21) Appl. No.: 14/439,806

(22) PCT Filed: Nov. 4, 2013
(86) PCT No.: PCT/CA2013/000929

§ 371 Date: Apr. 30, 2015

Related U.S. Application Data
(60) Provisional application No. 61/848,603, filed on Jan. 8, 2013.
(60) Provisional application No. 61/852,545, filed on Mar. 18, 2013.

(30) Foreign Application Priority Data
Nov. 2, 2012 (GB) 1219737.2

(51) Int. Cl. B66F 9/12; G01G 19/08; B66F 17/00

(52) U.S. Cl. CPC B66F 9/12; B66F 17/003; G01G 19/083

(57) ABSTRACT

The fork is cut into two pieces by abrasive waterjet. The toe-piece is formed with sidebars which, when the toe-piece is welded into the cover, greatly enhance rigidity of the cover-assembly. The heel-piece carries the load cells. In an option, a peninsula is cut in the heel-piece by waterjet, and the peninsula serves as the flexure-member of the loadcell.

This is a development of the technology disclosed in U.S. Pat. No. 6,730,861, which describes a system for adding a weigh-scale to the fork of a fork-lift truck. Generally, both forks of the truck are adapted, as a pair, for weighing.

Generally, in order to enable a weighing facility in respect of a fork-lift, designers provide a cover, which fits over the fork. Typically, the cover is made of sheet metal, and has the form of an inverted channel or trough, having a roof and left and right skirts or side-walls. The cover overlies the fork, such that the fork resides inside the inverted trough of the cover.

The loadcells by which the weight measurements are done are so placed that, when a load rests on top of the cover, the weight of the load is transmitted down through the loadcells to the fork. The cover itself should not touch the fork, during weighing—if the cover were to touch the fork, whereby a portion of the weight of the load was not “felt” by the loadcells, of course the weight-reading would be inaccurate.

Towards its toe-end, the undersurface of a lift-truck fork generally is tapered upwards, whereby the toe-end of the fork is quite thin. (The toe-end of the fork is tapered to enable the fork to slide easily into the fork-receiving-slot of a standard pallet, resting on the ground.)

Desirably, the designers should locate the toe-end loadcell close to the toe-end tip of the fork. The greater the distance of the loadcell back from the tip, the greater the bending stress on the portion of the cover that projects forwards from the loadcell.

However, there is a limit to how close the loadcell can be to the tip of the fork. For proper and adequate mounting of the loadcell, the fork needs to be of a good thickness at the place where the loadcell is mounted. But the tip of the toe-end of the fork is thinner, due to the toe-end taper. Typically, the toe-end loadcell is placed about fifteen centimetres back from the fork-end.

The toe-end of the cover can therefore have a considerable cantilevered overhang—the overhang being the portion of the cover that extends forwards from the toe-end loadcell. So, if the weight of a load should happen to rest at or near the tip of the fork rather than in the area of the loadcell (as can easily occur), the bending stresses on the cover can be considerable. Again, the cover should not be allowed to deflect so much that the cover actually touches the fork (at least, not when taking the weight reading), since that would drastically affect the accuracy of the weight measurement.

Even when the load is residing fully engaged with the forks, the cover needs to be stiff so as not to sag under the weight of the load. The left and right side-walls or skirts of the channel-form of the cover serve to stiffen the cover against bending moments that arise in the cover. However, towards the toe-end of the cover, the skirts have to be tapered to match the taper of the fork, to ease entry into the pallet slot. Thus, at the location where stiffness is critical, the stiffening effect of the skirts is diminished.

It is the case, also, that the space above the top-surface of the fork is at a high premium. If the cover adds more than a few millimetres to the overall thickness of the fork-plus-cover, there may be difficulties in engaging the forward end of the fork-plus-cover into the fork-receiving slots in standard pallets. Thus, the designers, faced with the need for a stiffer, more rigid, cover, preferably should provide the extra stiffness without resorting to increasing the thickness of the roof of the cover.

U.S. Pat. No. 6,730,861 discloses one way in which the cantilevered toe-end of the cover can be reinforced, without compromising the ability of the fork-lift-truck assembly to perform its main functions.

In '861, the toe-end of the fork was cut off. In '861, the cut-off tip, having been re-shaped (by machining), was welded to the underside of the cover. Also, reinforcing ribs 24 were welded into the cover, i.e were welded to the skirt-walls of the cover. The overhanging forward portion of the cover was stiffened and reinforced by the presence of the tip, and by the ribs. The reinforcing ribs make a significant contribution to the resulting overall bending stiffness of the cover-assembly. The ribs extended right back to the area of the cover at which contact with the loadcell is made.

As a result of these measures, there was a significant increase in the rigidity of the forward end of the cover.

The present technology follows the above principles, in that a toe-piece is cut off the fork, and the cut-off toe-piece is used to increase the bending rigidity of the overhanging toe-end of the cover. The present technology also provides the reinforcing ribs that extend from the cut-off toe-piece of the fork and are e.g welded to the skirts of the cover.

It is an aim of the present technology to stiffen the toe-end of the cover-assembly, as was done in U.S. Pat. No. 6,730,861, but in a manner that is significantly simpler and less expensive. In the new technology, the ribs are not made separately from the toe-piece that is cut-off the fork. Rather, the manner of cutting off the toe-piece is now selected on the basis of permitting the stiffening ribs to be included in the monolithic toe-piece. That is to say: the process by which the toe-piece of the fork is separated from the heel-piece of the fork is such that the stiffening ribs are left intact and in place on the toe-piece.

An example of a cutting process that enables the ribs to be included in the monolithic toe-piece is abrasive waterjet cutting.

Waterjet cutting of the fork eliminates the need for separate welded-in reinforcing ribs, in that now the ribs can be incorporated monolithically into the toe-piece of the fork. The waterjet cut that separates the toe-piece from the heel-piece follows a pre-defined pathway that shapes the left and right ribs, monolithically in the toe-piece.

In a development of the invention, waterjet cutting is also used to create a loadcell (preferably, two loadcells) monolithically in the metal of the heel-piece of the fork.

### LIST OF THE DRAWINGS

FIG. 1 is a pictorial view of a fork for a fork-lift truck, into which has been incorporated a weigh-scale unit. The load to be picked up now rests on a cover placed over the fork. The load-cells and other associated components are housed underneath the cover.

FIGS. 2,3 show modifications to the fork of the truck. The fork is cut into two pieces, being a toe-piece of the fork and a heel-piece, by waterjet cutting.

FIGS. 4,5,6 show how the heel-end of the fork is machined, creating receptacles for loadcells, and channels for the cables of the strain-gauges of the loadcells.

FIGS. 7,8 show how the toe-piece is attached into the cover, to form a cover-assembly.

FIG. 7 is an exploded view of spacers and the toe-piece about to be tack-welded to the underside of the inverted-channel-section of the sheet-metal cover.

FIG. 8 is a view from underneath the cover-assembly with those components assembled. The cut-off toe-piece of the fork is welded to the spacers. It may be noted that the toe-piece is re-used as-is; no further processing is required in respect of the piece, after waterjet cutting. The heel-end of the fork has to be machined in order to provide receptacles for the toe-end and heel-end loadcells, but then, no machining of the heel-end piece is required in order to provide space to accommodate the sturdy reinforcing ribs, which are monolithic with respect to the toe-piece.

FIG. 9 is a plan view from above, and shows the assembly of the loadcells into the heel-piece. In FIG. 9 the cover has been removed from the cover-assembly, but the spacers and the toe-piece of the fork are shown in the places they occupy when the cover, with the spacers and tip attached, is present.

FIG. 10 is a cross-sectional on the centreline of the view of FIG. 9.

FIG. 11 is side-elevation corresponding to FIG. 9. Again, (just) the cover is not present in FIGS. 9,10,11.

FIG. 12 is a cross-section like that of FIG. 10, showing a close-up of the toe-end loadcell assembled into the heel-piece of the fork, and with the cover and associated components in place. It can be understood from FIG. 12 that, when a load is resting on the cover, and the loadcell deflects downwards, and the cover-assembly comprising the cover, the spacers, and the toe-piece, all move downwards in unison.

FIG. 13 is a plan view of a fork.

FIG. 14 is the same plan view, after the fork has been subjected to abrasive waterjet cutting, which separates the fork into a toe-piece and a heel-piece.

FIG. 14A is a pictorial view of the same.

FIG. 15 shows the separated heel-piece.

FIG. 15A is a pictorial view of the same.

FIG. 16 shows the separated monolithic toe-piece, comprising a toe-end-block and left and right sidebars.

FIG. 16A is a pictorial view of the same.

FIG. 17 is a plan view (from underneath) of a channel-section folded sheet-metal cover.

FIG. 17A is a pictorial view of the same.

FIG. 18 shows the toe-piece of the fork now welded to the cover to form a cover-assembly.

FIG. 19 shows the cover-assembly now bolted into position on the heel-piece of the fork.

FIG. 20 is a pictorial view of the cover-assembly, showing the left and right sidebars of the toe-piece welded to the left and right skirt-walls of the cover.

FIG. 21 is a sectioned view on the line 21-21 of FIG. 19.

FIG. 21A is the same view, but shows the components as deflected under load.

FIG. 22 is a sectioned view on the line 22-22 of FIG. 19.

FIG. 22A is the same view, but shows the components as deflected under load.

FIG. 23 is a sectioned view on the line 23-23 of FIG. 19, showing the components as deflected under load.

The manner in which the fork is adapted for use with the weighing apparatus, and is combined with the weighing apparatus, will now be described.

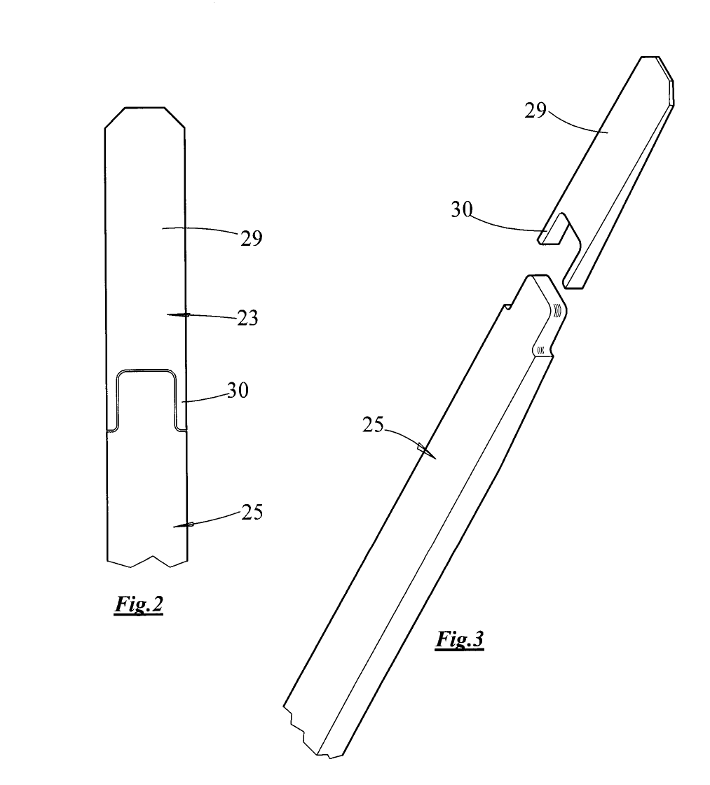

FIGS. 2,3 show (part of) a fork 20, and show the fork being separated into two pieces, a toe-piece 23 and a heel-piece 25. The separation is done by a waterjet cutting machine, which creates a kerf or pathway 27 having a width-W. The width-W typically is one to two millimetres. The abrasive waterjet machine includes a cutting head, in which particles of sharp-edged garnet or the like are entrained in a high-pressure/high-speed jet of water. The workpiece rests on a bed of slats, in the machine, and the cutting head is programmed to traverse over the workpiece, following a pre-determined path. (The waterjet cutting machine and technology are conventional, and not described herein.)

The monolithic toe-piece 23, now separated, has a toe-end-block 29 and left and right sidebars 30, which extend from the toe-end-block towards the heel-end of the fork. An open space is created between the two sidebars 30.

The heel-piece 25, now separated, can be fitted back together with the toe-piece, in the manner as shown in FIG. 2. For the purposes of measuring the weight of a load supported by the fork, the toe-piece 23 moves up/down relative to the heel-piece 25 (i.e in the direction in/out of the plane of FIG. 2) and the two pieces lie spaced the width of the kerf apart, in the FIG. 2 position, whereby the two pieces do not make contact during such movement.

FIGS. 4,5,6 show the machining that is carried out in respect of the top surface 32 of the now-separated heel-piece 25. Receptacles 34 for loadcells, and channels 36 for wiring, are provided.

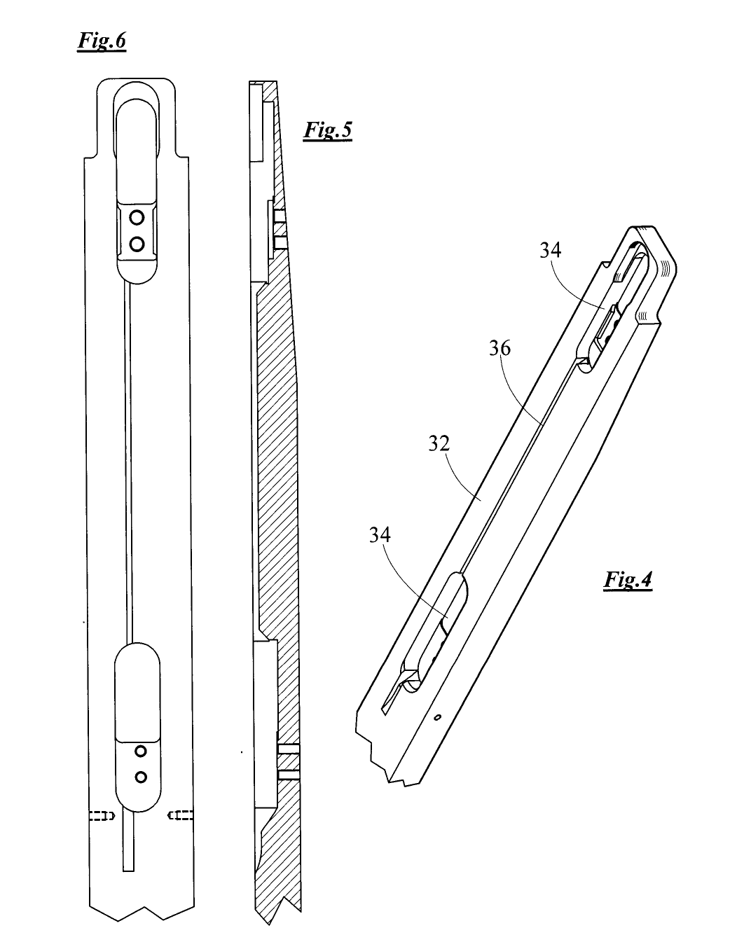

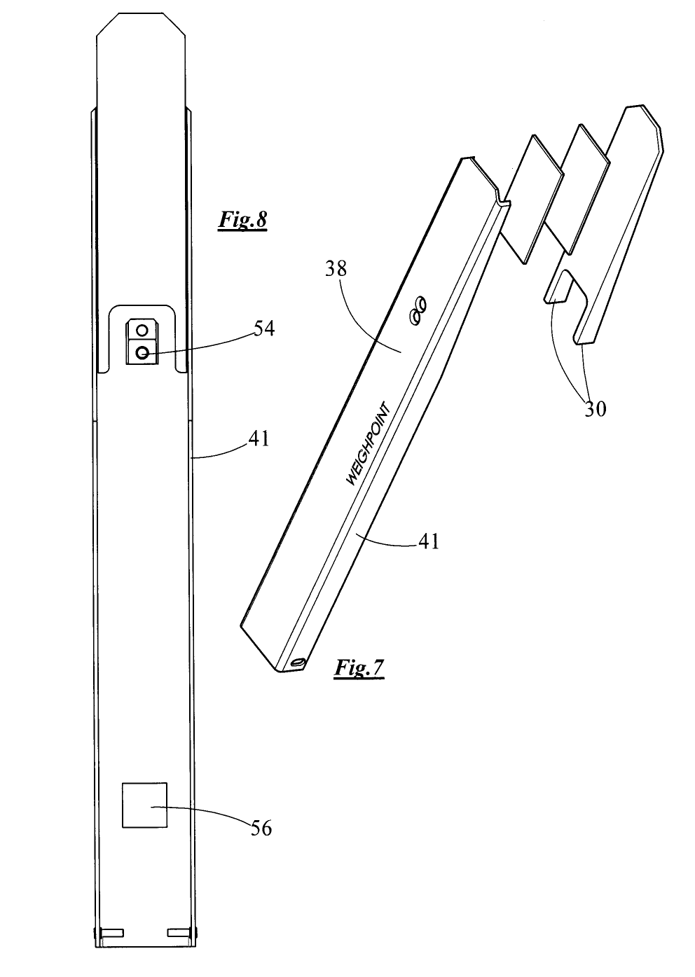

FIGS. 7,8 show a cover 38, which is made from folded sheet metal. The cover overlies the fork, such that the load to be carried by the lift-truck actually rests on the cover 38, rather than on the fork. The cover 38 is supported above the heel-piece 25 of the fork by the toe and heel loadcells.

The toe-piece 23 of the fork is integrated with the cover 38, in this case by welding, to form a unitary cover-assembly 40. The left and right sidebars 30 are welded to the folded skirt-walls 41 of the cover 38. FIG. 8 is a view from underneath the cover-assembly, and shows some of the fittings associated with the loadcells.

FIGS. 9,10,11 show the cover-assembly 40 now attached to the heel-piece 25 of the fork. (In fact, in these drawings, the cover 38 itself has been omitted, for clarity. Again: the cover 38 is integrated, by welding, with the toe-piece 23, to form the cover-assembly 40.)

Two loadcells are provided, being a toe-loadcell 44T and a heel-cell 44H. The loadcells have respective flexure-members 49, having respective fork-ends 50 and cover-ends 52. As shown, the fork-ends of the flexure-members 49 of the loadcells 44 have been integrated, by fork-bolts 47, into the receptacles 34 in the heel-piece 25.

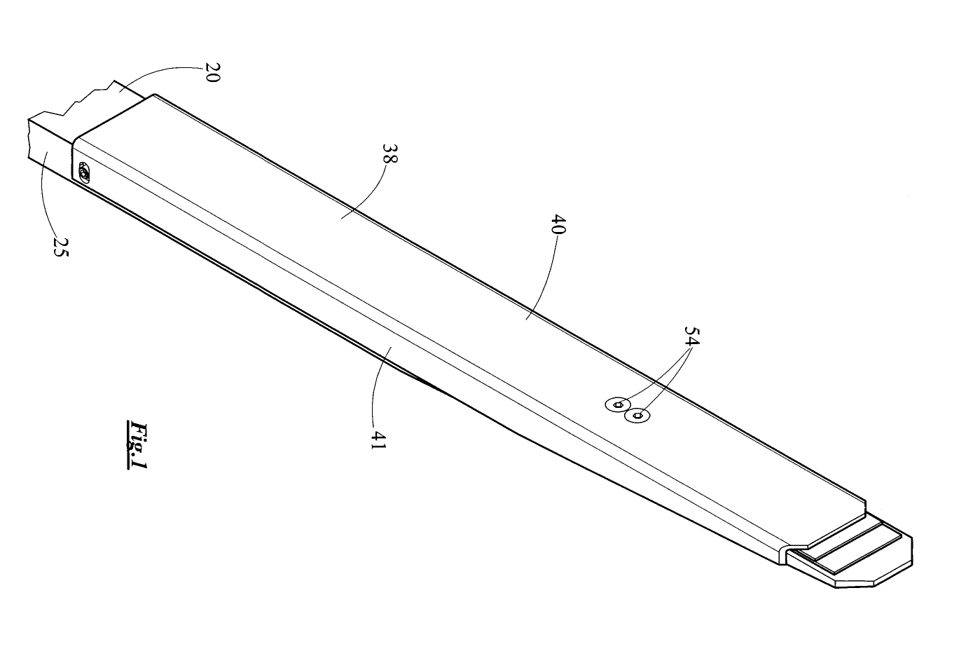

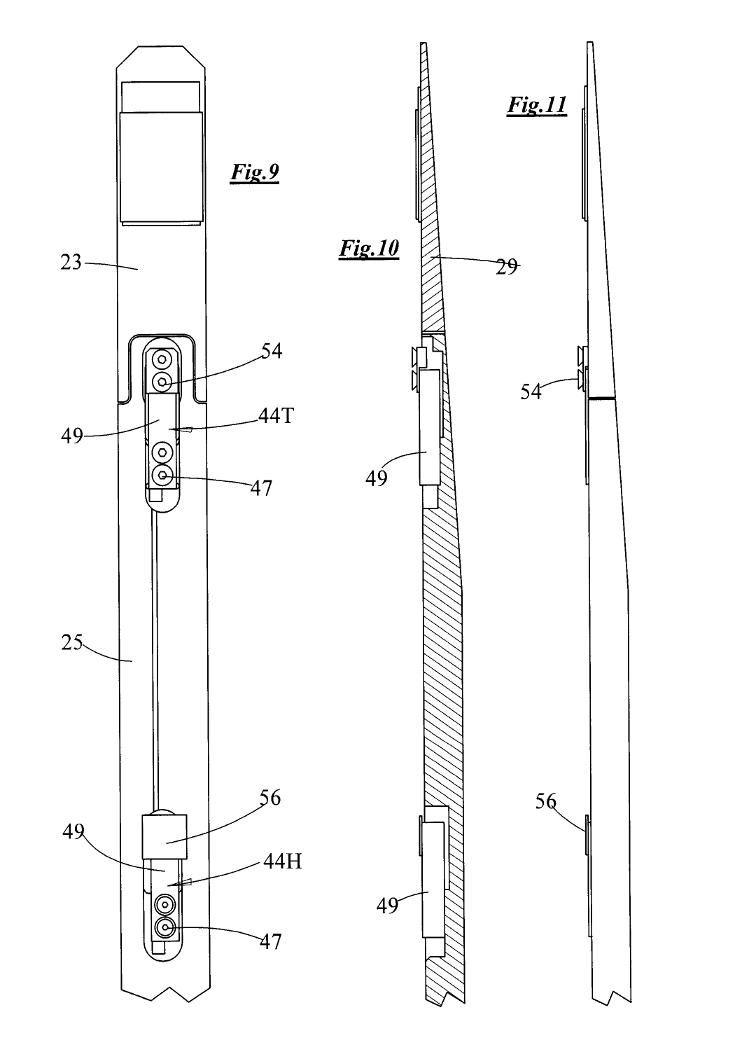

When a load is resting on the cover 38, the cover-ends 52 of the flexure-members 49 bend downwards. The cover-assembly 40 is integrated, by cover-bolts 54, into the cover-end 52T of the toe-loadcell 44T. Thus, the cover-assembly is unitary with the cover-end 52T of the toe-loadcell 44T, and moves up/down with the cover-end 52T for the purposes of supporting and measuring the weight of the load. The cover-assembly 40 is not integrated into the cover-end 52H of the heel-cell 44H, but rather the cover-assembly simply rests on a support-pad 56 provided on the cover-end 52H. Strain-gauges (not shown in FIGS. 1-12) measure the bending deflection of the two flexure-members 49.

At the toe-end loadcell, an insert is provided, which may be bolted directly to the cover (as shown), or may be tack-welded to the cover. The insert assists in keeping the cover tight to the forward end of the toe-end loadcell.

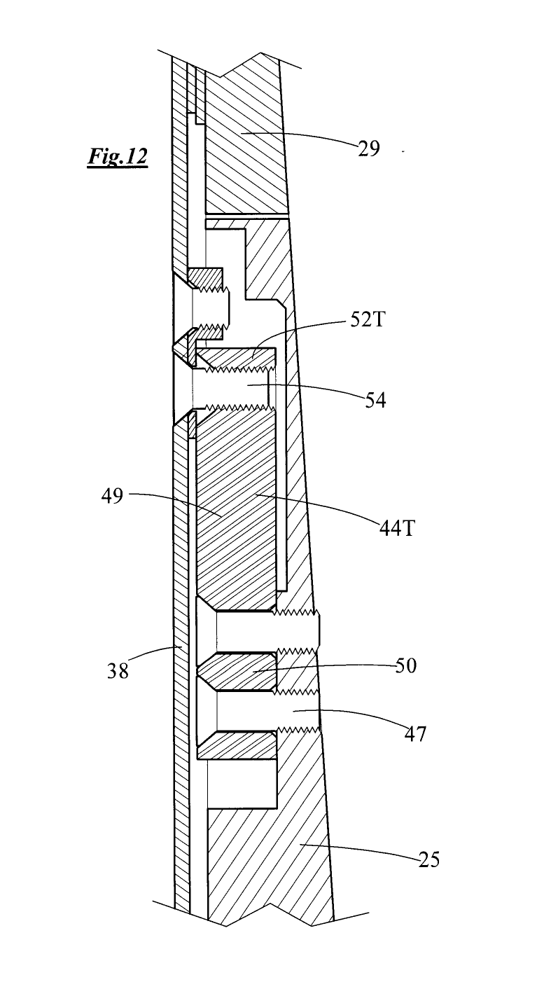

FIG. 12 shows the manner of attaching the cover-assembly 40 to the cover-end 52T of the flexure-member 49 of the toe-loadcell 44T. In FIG. 12, the cover 38 itself is now present.

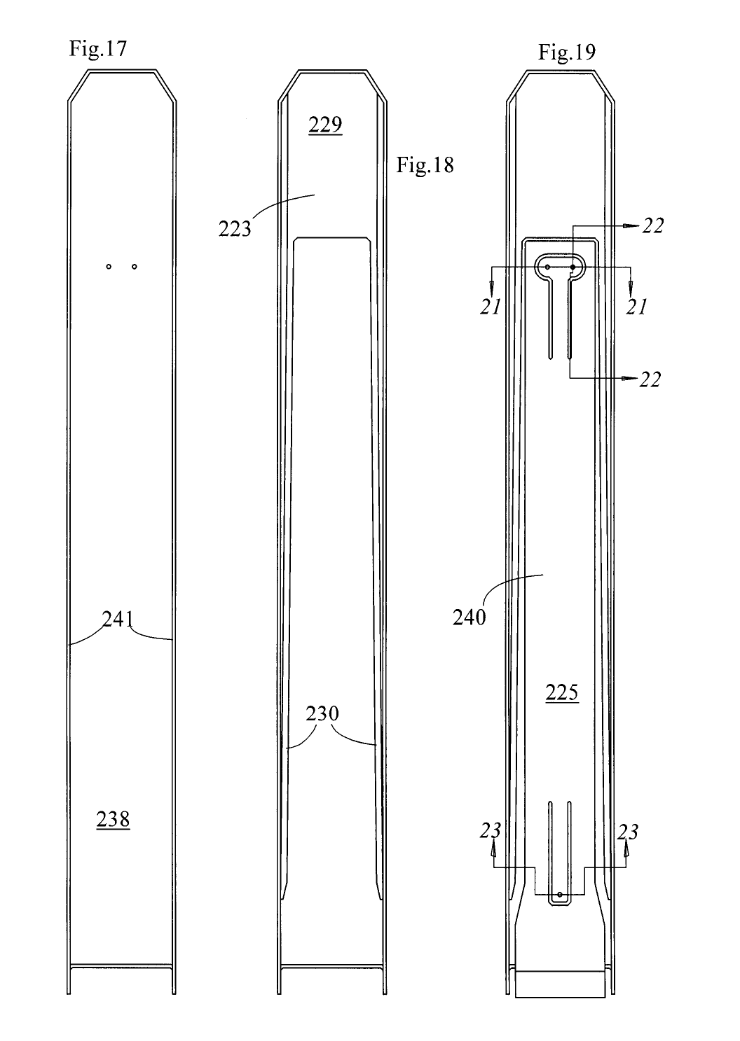

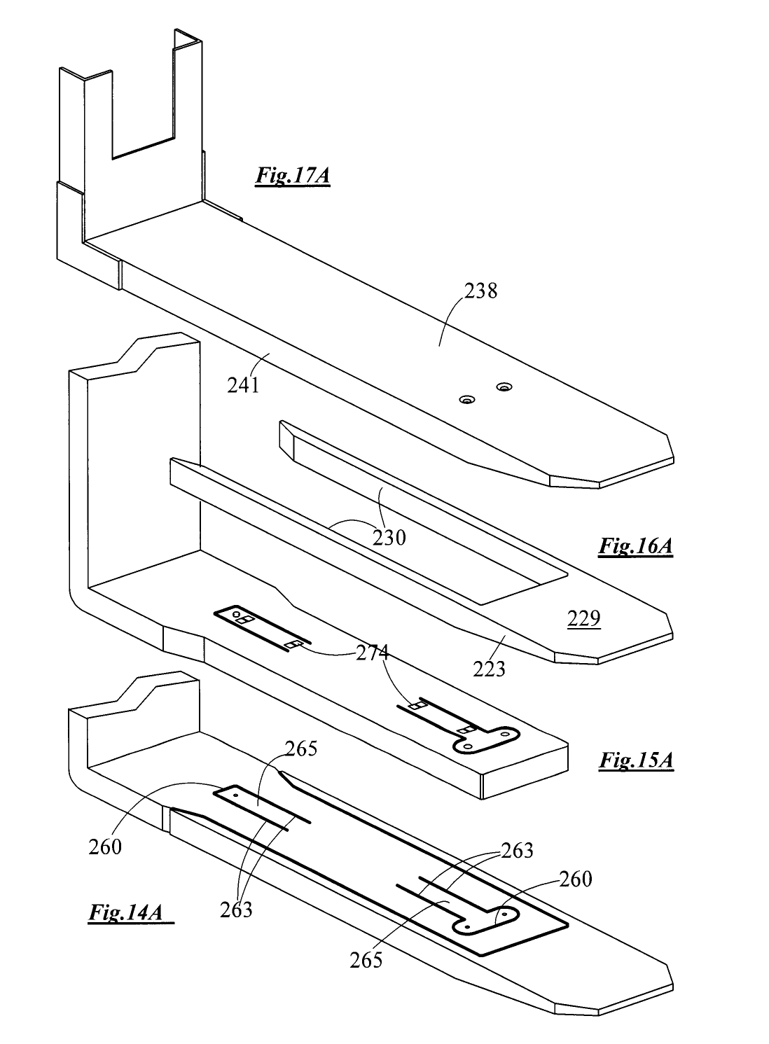

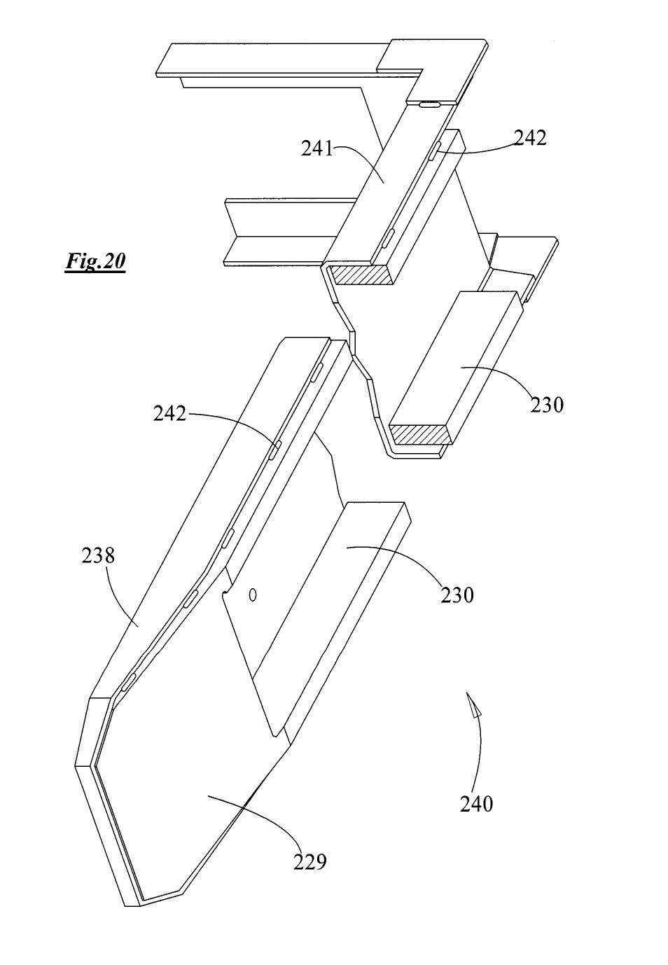

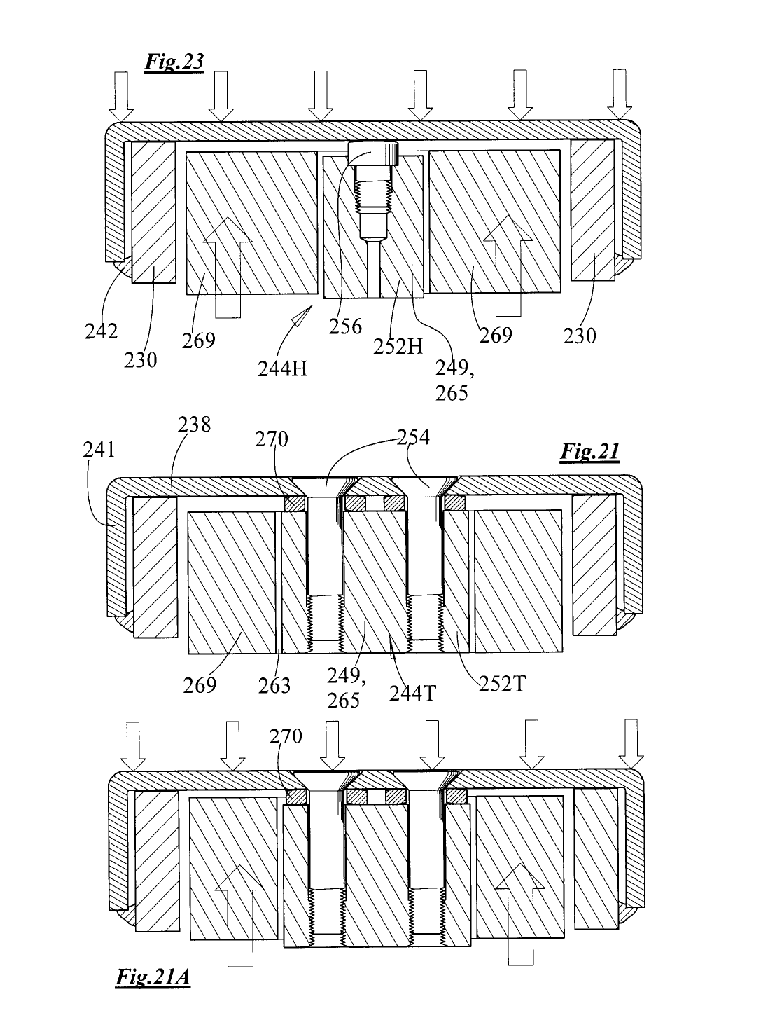

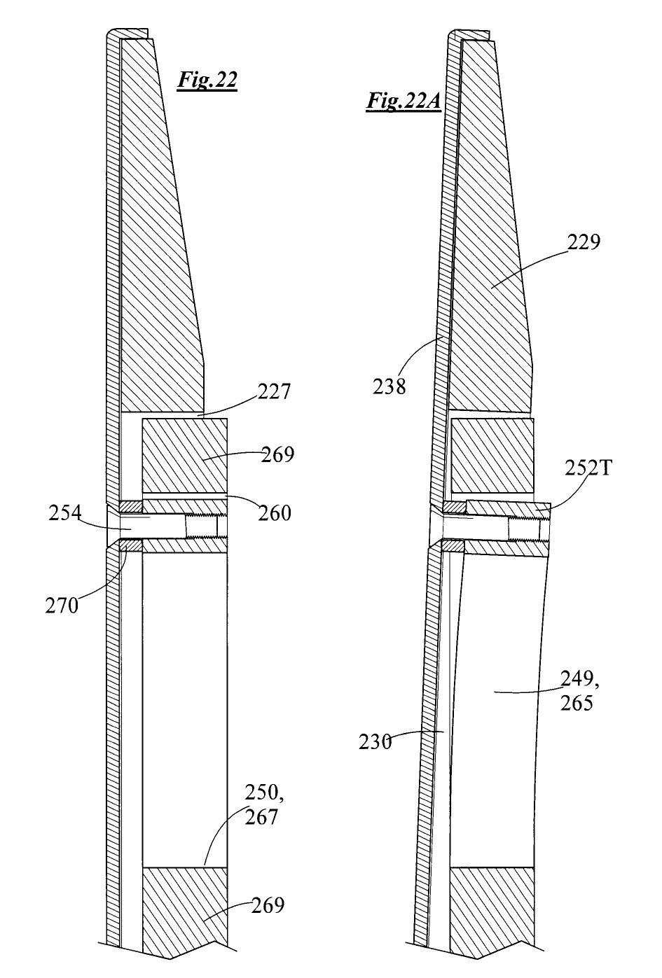

FIGS. 13-23 show another manner in which the characteristics of waterjet cutting can be used advantageously in forks-adapted-for-weighing technology.

FIG. 14 shows the pathways traced by the cutting head over the fork, which again provide a ken of width-W. Again, the cover-assembly 240 is formed by integrating (by welding, as at 242) the sidebars 230 with the folded skirt-walls 241 of the cover. But now, the side-bars 230 are much longer, and in fact extend over more or less the whole length of the cover 238. Thus, the bending rigidity of the whole cover-assembly is much enhanced.

In FIGS. 14,14A,15,15A,21,21A,22,23,23A, the flexure-members 249 of the two loadcells have now been formed directly in the material of the heel-piece 225 of the fork.

The waterjet pathway that is used to create the flexure-member 249 has the shape of an elongated-U, in that the pathway comprises a width-path 260 linking two length-paths 263, which terminate in blind-ends. Cutting this U-shape into the heel-piece 225 of the fork creates a peninsula 265. The peninsula 265 is cantilevered outwards from a cantilever-root-area 267 of the main-body 269 of the heel-piece 225. The heel-piece 225, including the main-body 269, the peninsula 265, and the cantilever-root area 267, is monolithic. The peninsula 265 serves as the flexure-member of the loadcell.

Thus, there are no fork-bolts, by which the fork-end 250 of the flexure-member (i.e the peninsula 265) is integrated with the heel-piece 225. The fork-end 250 of the flexure-member 265 is already integrated with the main-body 269 of the heel-piece 225 of the fork, in that the heel-piece 225, including the peninsula 265, is monolithic.

The unitary cover-assembly 240 is integrated (by cover-bolts 254) with the cover-end 252 of the flexure-member (being the distal-end of the peninsula 265). As shown, the width-path 260 has traced out a widening on the distal-end of the peninsula, to accommodate the cover-bolts 254 side by side. Alternatively, the two cover-bolts could be arranged in line. The (vertical) distance by which the cover-assembly 240 is spaced from the top-surface of the fork is determined by the thickness of the washers 270 around the cover-bolts 254. Preferably, these should be belleville washers (disc springs), which prevent the bolts from slackening over a long period of service by keeping the bolts in tension, even under the heavy compressive loads.

It can sometimes happen that the bolt(s) holding the cover-assembly to the heel-piece of the fork might break. This can be very dangerous in that the cover-assembly, and the load being carried thereon, can fall off. The waterjet can be used to create a lock that prevents the cover-assembly form separating from the heel-piece, in such a case. The lock is illustrated (only) in FIG. 14 at 272. The cover-assembly can now only be separated from the heel-piece of the fork by lifting the cover-assembly upwards off the fork. It may be noted that the lock 272 is created virtually for nothing.

The distal-end 252H of the peninsula 265 that forms the heel-loadcell 244H is formed with a support-pad 256, which supports the cover, but the cover-end of the heel-cell 244H is not integrated with the cover 238.

Strain-gauges 274 are cemented to the top surface of the peninsulas 265. Wires convey the signals therefrom to the cab of the lift truck, in the conventional manner. The strain-gauges measure the elongation of the top surface of the peninsula as the peninsula deflects in bending under the weight of the applied load.

FIGS. 21,22 show the peninsula 265 of the toe-loadcell 244T in its unladen, undeflected, state. In FIGS. 21A,22A, there is a load resting on the cover, and the distal-end 252 of the peninsula 265 has deflected downwards. The cover-assembly 240 has moved downwards also, following the deflection of the peninsula.

Using waterjet technology to separate the toe-piece of the fork from the heel-piece has a number of advantages.
(a) The waterjet cutter can cut around corners, or cut a curve, as easily (although not quite as quickly) as it can cut a straight line.
(b) With waterjetting, the cut faces and edges are of good finish, with no burrs. The waterjetted components can be used as-is, and no dressing or finishing is required.
(c) Waterjet cutting is practical for one-off jobbing-type tasks, or small runs. It uses simple tooling and set-up. Generally, the task of adding a weigh-scale to the forks of a lift-truck is done on a one-off, or few-off, or small batch, basis, for which waterjet-cutting is very suitable.
(d) Upon assembly as in FIG. 9, the separated toe-piece and heel-piece of the fork occupy the same positions relative to each other as if they had never been cut apart. Waterjetting the cut means that the two cut faces are always an exact fixed uniform distance apart. This is useful in the present case, where there should be no contact between the heel-piece and the toe-piece, and yet at the same time the sidebars of the toe-piece should be chunky and robust. If a larger clearance space had to be provided, e.g for tolerance reasons, that extra space likely would have to be at the expense of the chunkiness of the sidebars. In short, when the components are assembled as in FIG. 9, the toe-piece and the heel-piece of the fork go back into the same positions relative to each other that they occupied before the cut was made, and yet they are spaced apart adequately to ensure that they do not touch when the cover moves as the loadcell deflects under heavy load.
(e) The waterjet cutting process is more expensive than e.g sawing; however, overall, the cost saving is high. This can be understood from a perusal of U.S. Pat. No. 6,730,861, which involves making the ribs 24, machining the shapes required on the fork-stub and the fork-tip, much welding, difficult inspection, and so on. The '861 system carries a high skilled-craftsman labour cost.
(f) The sidebars of the cover-assembly are in just the right place to add considerable rigidity to the cover. And the sidebars are already integrated with the toe-end block of the monolithic toe-piece, and do not need to be attached to the toe-end-block. Compared with the high cost and general difficulty of providing and adding the ribs 24 in '861, it is as if, in the present technology, the sidebars are provided for nothing.
(g) It is a simple matter, with waterjet cutting, to provide a kerf that is one or two millimetres wide. That width of kerf provides the clearance gap between the assembled toe-piece and heel-piece that is required during operation. Such a gap is about ideal, from the standpoint of being not so small that touching might occur, nor yet so large as to cut down on the chunkiness of the sidebars.
(h) In the present technology, the separated toe-piece is immediately ready, without further processing, to be welded into the cover. No machining of the toe-piece is required, at all. (With regard to the heel-piece, cutting the blind-end pathways requires a starter-hole to be made through the thickness of the heel-piece. Designers might favour the option of making the starter-hole by drilling the hole, rather than by impacting the waterjet.)

Some of the above features apply to waterjet cutting in general, but the present technology makes use of all the features in combination. The advantageous aspects of performance of function can be attributed to the use of waterjet-cutting in the special case of the present technology, have not been utilized and/or recognized in combination in previous applications to which waterjet-cutting has been put. Equally, the conventional and traditional ways of adapting forks for weighing, have fallen short of the highly practical and economical technology as described herein.

There are other metal-cutting technologies, i.e other than waterjetting, in which the cutting head traverses along a predetermined pathway. However, the cutting-by-burning techniques, including laser, plasma, flame, etc, cannot economically cut steel of 3.5 cm thickness, which is typical thickness for a lift-fork, whereas waterjet-cutting easily and economically copes with such thicknesses. Waterjetting also leaves the cut surfaces smooth and even and free of such burrs and sharp edges as would require dressing. Waterjetting is clean and precise. Waterjetting does not give rise to a heat-affected-zone (unlike the cutting-by-burning processes)—which can be important given the long-slender configuration of the sidebars that are part of the monolithic toe-piece. Waterjetting does not inherently cause distortion or warping of the long slender sidebars.

Kerf-width, or pathway-width, is important. In the present technology, the toe-piece and the heel-piece are separated by waterjetting, and then those two pieces are brought together again for operational purposes: the kerf-width would be too small if there were a danger of the brought-together pieces actually touching each other; while the kerf-width would be too large if the large kerf were to reduce the robust chunkiness of the sidebars. A kerf-width of one to two mm fits these criteria, and a kerf of that size is very good for waterjetting at the material thicknesses encountered.

It will be understood that, during operation of the fork to indicate the weight of a load resting on the cover-assembly, the fit of the toe-piece of the fork to the heel-piece is important. While it is possible to match the toe-piece from fork-FX with the heel-piece from fork-FY, the fact is that fork-FX and fork-FY are often not accurately matched as to dimensions and properties. Mismatch problems can be eliminated by ensuring that, after they have been waterjetted apart, the toe-piece of fork-FZ stays with the heel-piece of fork-FZ, as a pair. This is not difficult, logistically.

The present technology can be applied when adding a weigh-scale to fork-lift-trucks of many varieties, particularly trucks in which the forks cantilever out from a mast etc. This includes the kind of fork commonly called an order-picker, for example. The technology is less preferred in the case of the kind of lift truck commonly called a walkie-truck, in which the fork is provided with support-wheels.

Forks for lift trucks come in many shapes and configurations. The present technology is generally applicable, provided the fork lends itself to being cut by abrasive waterjetting. In the described embodiments, the (forged steel) forks were 12 cm wide, 3.5 cm thick, and 106 cm long. The (sheet steel) cover was 5 mm thick.

The notion of creating a loadcell in the monolithic heel piece is made possible by waterjetting. It should be noted, in this regard, that the class of steel typically used for the forks of lift-trucks, is more or less the same as the class of steel typically used for the flexure-members of load cells. Thus, it is an easy matter for designers to produce a load-cell of high-quality, given that the steel of the fork, from which the load-cell is to be made, is already a toughened spring steel.

It is important to ensure that the cover-assembly, which includes the toe-piece of the fork, is accurately aligned with the heel-piece of the fork, in the positions shown in e.g FIG. 9, or FIG. 14a. The designers should see to it that, when the cover-assembly is being bolted to the cover-end of the toe-loadcell, that none of the surfaces of the cover-assembly is touching any surface of the heel-piece. (Operators/users would be concerned that friction at such a contact point would or might affect the accuracy of the weight reading.) Thus, when integrating the cover-assembly with the cover-end of the toe-loadcell, designers should see to it that the components are adequately jigged, so the required clearance is built into the manner of integration.

The use of two cover-bolts is preferred over just one bolt, for two reasons. First, two bolts hold the cover-assembly firmly against rotating laterally; if only one bolt were used, the cover-assembly might (e.g upon the fork being impacted against a wall, etc) pivot about that one bolt, and the cover-assembly might then make contact with the heel-piece. Second, if two bolts are used, each bolt can be smaller, which means the bolt has a smaller head, which means in turn that the thickness of the metal of the cover can be minimized.

As mentioned, adding a cover over the fork inevitably makes it more difficult for the driver to insert the fork into the fork-slots of a pallet. Thus, when forks are adapted to provide a weighing capability, the users seek a cover in which the headroom above the fork has been minimized. The cover itself should be as thin (vertically) as possible, and should lie as close as possible to the top of the fork (without touching the fork). At the same time, of course, the apparatus should be robust, with adequate margins of safety, and taking account of manufacturing tolerances and expected operational abuses. A measure that enables the headroom required by the cover to be a millimetre smaller, truly without compromising performance, is regarded very favourably. The use of waterjet cutting, as described, enables the cover-assembly to have very good rigidity, and enables the headroom to be minimized.

By the use of waterjet cutting, the cutter can produce whatever pathway is programmed into the coordinates of the movable table or platform of the waterjet machine. It is easier, in waterjet cutting, if the cut can be open-ended, i.e if the cut can come in from an edge or side of the workpiece. However, it is perfectly possible for the cut to be a blind-cut, i.e the start of the cut is at a point of the work piece that is remote from the nearest edge. When the waterjet cut is to be a blind-cut, the operators can arrange to (mechanically) drill a hole through the workpiece at the location of the start of the cut, or the waterjet can be set to dwell on that location, whereby the waterjet will pierce a hole right through the thickness of the workpiece.

It will be observed, especially in FIGS. 14,15,18,19, that the width of the heel-piece of the fork has been reduced by the pathway cut by the waterjet. It should be noted that the design strength of the (forged) steel fork is aimed at the large stresses that are encountered in the heel-bend of the fork. Away from the heel-bend, the stresses are much reduced, and the (small) loss of width, as shown, does not affect the strength of the fork.

For measuring the load supported by the fork, the load rests on the unitary cover-assembly that overlies the fork. The cover is held clear of the fork by the flexure-members of the toe- and heel-loadcells.

The fork-ends of the flexure-members of the loadcells are integrated with the heel-piece of the fork. As described in U.S. Pat. No. 6,730,861, one of the load-cells can be tightly bolted to the cover, but the other load-cell should support the cover, and support the weight of the load resting on the cover, but should not be tightly bolted to the cover. The reason the cover should not be tightly bolted to both loadcells may be understood as follows.

When a heavy load is resting on the cover, the fork undergoes bending deflection. The length of the upper surface of the fork thereby increases. (The length of the lower surface correspondingly decreases.) Thus, when a heavy load is supported by the fork, the toe/heel distance between the toe-loadcell cover-bolt and the heel-loadcell cover-bolt, as measured over the upper surface of the fork, increases. If the cover were tightly bolted to both load cells, the cover would connect the toe-cover-bolts and the heel-cover-bolts in more or less pure tension, and consequently the length of the cover would increase hardly at all. Thus, the bending of the fork would require the bolts to move apart, while the cover would prevent the bolts from doing so.

If the cover were tightly bolted to both loadcells, the cover-bolts would be subjected to shear forces that could damage the bolts. In fact, it can happen, if the cover is tightly bolted to both loadcells, that one of the cover-bolts might be sheared off. (Once one of the cover-bolts has sheared off, shear stresses on the other cover-bolt drop to zero.)

It is also the case that the shear force that is induced in the cover-bolts by the bending of the fork is felt by the flexure-members of the loadcells as tension in the toe/heel direction. But the tension deflection of the flexure-member is the very means by which the strain gauges measure the magnitude of the weight of the load. Thus, if the cover is tightly bolted to both loadcells, even if the bolts survive, significant inaccuracies of measurement of the load can result.

For the above reasons, while one of the loadcells can be tightly bolted to the cover, the other loadcell should not be tightly bolted to the cover. Rather, the other loadcell should support the cover, and should permit the cover to move in the toe/heel direction relative to the fork—far enough that the bolts are isolated from the effects of the bending of the fork. Typically, the other loadcell should permit relative movement between the cover and the fork of about a millimetre.

In the drawings, the heel-cell is not tightly bolted to the cover, but rather the cover is supported by a pad, which is fixed into the distal-end of the peninsula of the hell-cell. Thus, the heel-end of the cover can simply slide in the toe/heel sense relative to the heel-end of the fork, to accommodate the deflection difference.

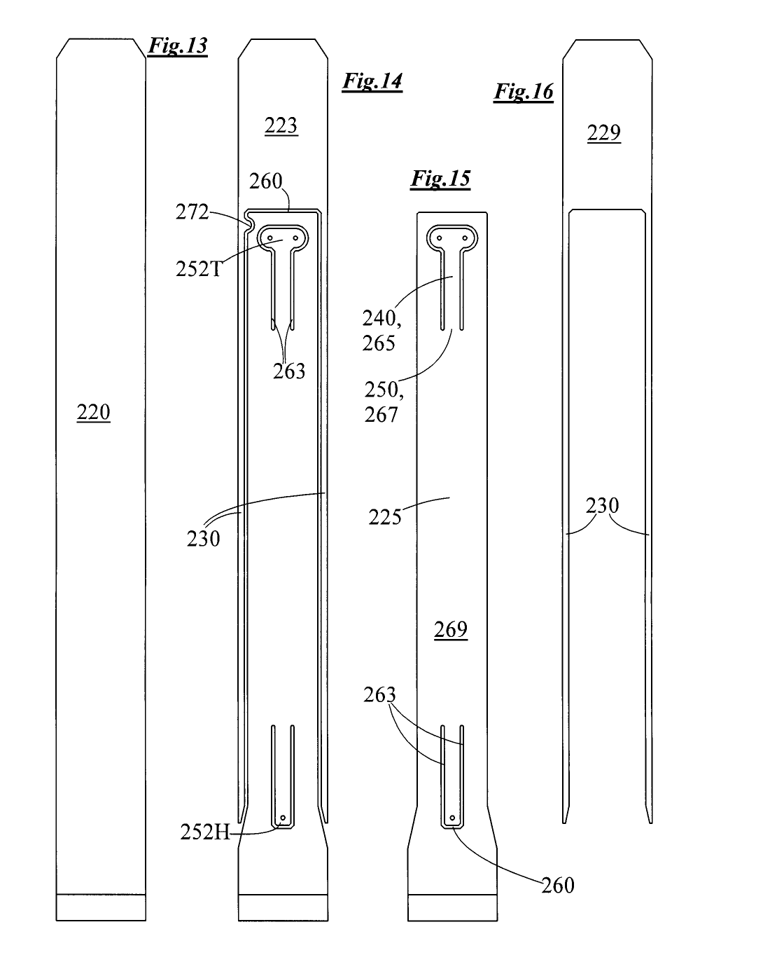

It should be emphasized that the cover-assemblies as described herein, particularly the cover-assembly as depicted in FIG. 20, is much stronger and more rigid than many traditional cover-assemblies. This is mainly due to the presence of the long sidebars 230 which are welded to the skirt-walls 241 of the cover. From e.g FIGS. 16,16A, it can be seen that the sidebars have very little rigidity in themselves. It looks as though as soon as even a small force is applied to the sidebars, they will bend and buckle aside. The sidebars are enabled to make their very great contribution to the rigidity of the cover-assembly by the fact of being integrated into the cover-assembly, and the fact of the channel-shape of the cover. Thus, the presence and shape of the cover-assembly keeps the sidebars from deviating out of position, and thus enables the sidebars to stiffen the skirt-walls.

The thickness of the sheet metal of the cover can be minimized, making the cover-assembly lightweight, but yet the cover is very strong and rigid. Furthermore, the cover-assembly as depicted poses very little headroom penalty. Furthermore, once the fork has been set up in the waterjet cutting machine, it is very economical to make further cuts, whereby the huge rigidity of the FIG. 20 cover-assembly can be had almost for nothing.

Because the pathways are cut in the fork by waterjet cutting, not only are the sidebars 30,230 included in the monolithic toe-pieces 30,230, but the flexure-members 265 are included in the monolithic heel-piece 225. The flexure-member of the load cell being monolithic with the material of the heel-piece of the fork, the loadcell could hardly be simpler to make, nor more robust. The loadcells cannot be misaligned. The calibration of the loadcells, once set, can be expected to be very long-lasting. The construction of the loadcells of FIGS. 14A,15A,23,2A can be compared with the loadcells depicted in FIGS. 9.10, as to the differences in the amount of precision machining manufacture.

Some of the terms used in this specification are defined as follows:
Components A and B are “monolithic” when formed in the same piece of metal.
Components A and B are “unitary” when A and B either are monolithic, or, if formed as separate pieces, A and B are fixed (e.g bolted or welded) together in such manner that A and B perform their operational functions as if they were monolithic.
Components A and B are “integrated” when they perform their operational functions as if they were monolithic.

In this sense:
Monolithic components are integrated.
Bolted-together components are integrated.
Welded-together separate components are integrated.

The numerals used in the accompanying drawings are summarized as follows: (FIGS. 1-12)
20 fork
23 toe-piece of the fork
25 heel-piece of the fork
27 pathway of width-W, as made by waterjet cutter
29 toe-end-block of the monolithic toe-piece
30 left and right sidebars of the monolithic toe-piece
32 top surface of the fork
34 receptacles formed in the fork, for loadcells
36 channels formed in the fork, for wiring
38 cover, formed of folded sheet metal
40 unitary cover-assembly, comprising the cover plus the toe-piece, welded together
41 left and right side-walls or skirt-walls of the cover
44T toe-loadcell
44H heel-loadcell
47 fork-bolt, for bolting the fork-end of the loadcell to the fork
49 flexure-member of the loadcell
50 fork-end of the flexure-member
52T cover-end of the flexure member of the toe-loadcell
52H cover-end of the flexure member of the heel-loadcell
54 cover-bolt, for bolting the cover-end of the loadcell to the cover
56 support pad, located at the cover-end of the heel-loadcell, for supporting the cover (FIGS. 13-23)
220 fork
223 toe-piece of the fork
225 heel-piece of the fork
227 pathway of width-W, as made by waterjet cutter
229 toe-end-block of the monolithic toe-piece
230 left and right sidebars of the monolithic toe-piece
238 cover, formed of folded sheet metal
240 unitary cover-assembly, comprising the cover plus the toe-piece, welded together
241 left and right side-walls or skirt-walls of the cover
242 weld beads, between the cover and the sidebars of the toe-piece
244T toe-loadcell
244H heel-loadcell
249 flexure-member of the loadcell
250 fork-end of the flexure-member
252T cover-end (=distal-end) of the flexure member of the toe-loadcell
252H cover-end (=distal-end) of the flexure member of the heel-loadcell
254 cover-bolt, for bolting the cover-end of the loadcell to the cover
256 support pad, located at the cover-end of the heel-loadcell, for supporting the cover
260 width-path of the U-shaped pathway
263 length-paths of the U-shaped pathway
265 peninsula, formed in the monolithic heel-piece of the fork
267 cantilever-root-area of the peninsula
269 main body of the monolithic heel-piece
270 belleville washers
272 lock (FIG. 14)
274 strain-gauge of the loadcell

Some of the physical features of the apparatuses depicted herein have been depicted in just one apparatus. That is to say, not all options have been depicted of all the variants. Skilled designers should understand the intent that depicted features can be included or substituted optionally in others of the depicted apparatuses, where that is possible.

Some of the components and features in the drawings and some of the drawings have been given numerals with letter suffixes, which indicate left, right, etc versions of the components. The numeral without the suffix has been used herein to indicate the components or drawings generically.

Terms of orientation (e.g “up/down”, “left/right”, and the like) when used herein are intended to be construed as follows. The terms being applied to a device, that device is distinguished by the terms of orientation only if there is not one single orientation into which the device, or an image (including a mirror image) of the device, could be placed, in which the terms could be applied consistently.

Terms used herein, such as “cylindrical”, “vertical”, and the like, which define respective theoretical constructs, are intended to be construed according to the purposive construction.

The scope of the patent protection sought herein is defined by the accompanying claims. The apparatuses and procedures shown in the accompanying drawings and described herein are examples.

1. Procedure for manufacturing a fork, in combination with an apparatus for measuring a load supported by the fork, including:
where the fork has a toe-end and a heel-end, a top surface and a bottom surface, and left and right side surfaces;
using a cutting machine to cut a pathway through the fork;
where the cutting machine includes a cutting-head and structure for moving the cutting-head relatively to the fork;
so applying the cutting-head to the fork that the pathway extends from the top-surface right through to the bottom surface;
so moving the cutting-head relative to the fork that the pathway of width-W extends from the left side-surface right across to the right side-surface;
thereby separating a toe-piece of the fork from a heel-piece;
so moving the cutting-head that the separated toe-piece of the fork is characterized in that:
(a) the toe-piece is monolithic, and includes a toe-end-block and left and right toe-piece sidebars;
(b) the left and right sidebars of the monolithic toe-piece extend from the toe-end-block towards the heel-end of the fork;
providing a loadcell in the heel-piece, for measuring the weight of the load supported by the fork.

2. As in claim 1, wherein:
the cutting-head includes a waterjet, in which abrasive particles are entrained;
the cutting machine is an abrasive waterjet cutting machine, which cuts a pathway of width-W in the fork.

3. As in claim 2, including:
providing a cover, which is structured to fit over the fork;
integrating the toe-piece of the fork with the cover, whereby the cover and the toe-piece now form a unitary cover-assembly;
whereby the sidebars provide stiffening skirt-walls of the cover, thereby making the cover-assembly as a whole, when stressed in bending, deflect significantly less than the cover alone;
placing the unitary cover-assembly over the heel-piece of the fork.

4. As in claim 3, including:
where the cover is in the form of an inverted channel or trough, having left and right side-walls or skirt-walls;
where the cover is structured to fit over the fork, the fork being then located within the inverted channel;
placing the toe-piece inside the channel of the cover;
so arranging the toe-piece in the cover that the left and right sidebars of the toe-piece lie adjacent to the left and right skirt-walls of the cover;
integrating the toe-piece of the fork with the cover, including integrating the toe-piece sidebars to the skirt-walls of the cover, whereby the cover and the toe-piece now form the unitary cover-assembly;
whereby the sidebars stiffen the skirt-walls of the cover, thereby making the cover-assembly as a whole, when stressed in bending, deflect significantly less than the cover alone;
placing the unitary cover-assembly over the heel-piece of the fork.

5. As in claim 4, including:
where the loadcell includes a flexure-member, having a fork-end and a cover-end;
integrating the fork-end with the heel-piece of the fork, and integrating the cover-end with the cover;
so arranging the loadcell in the apparatus that the weight of the load resting on the cover is transmitted down from the cover to the cover-end of the flexure-member, through the flexure-member, and down from the fork-end of the flexure-member to the heel-piece of the fork;
so structuring the flexure-member as to undergo deflection of the cover-end relative to the heel-end, proportional to the load;
providing the loadcell with a strain-gauge, which measures the deflection of the flexure-member under load, and transmits a proportionate signal to a receiver;
so arranging the apparatus that the cover-assembly, at least during operation to measure the weight of the load, remains out of contact with the heel-piece of the fork;
being such contact that enables some of the weight of the load to be supported by the contact, rather than by the flexure-member.

6. As in claim 5, wherein:
the cover-end of the flexure-member is tightly bolted to the cover;
the cover-end of the second flexure-member supports, but is not tightly bolted to, the cover.

7. As in claim 5, including so integrating the cover-assembly with the toe-end of the flexure-member that the toe-piece and the heel-piece of the fork lie in substantially the same location relative to each other as before the pathway of width-W was cut, whereby the toe-piece now lies spaced apart from the heel-piece a distance equal to the width-W.

8. As in claim 1, wherein:
the toe-end-block extends from the toe-end of the fork at least ten cm along the length of the fork;
the toe-piece sidebars extend at least a further ten cm;
the toe-piece is so configured as to create an open space between the left and right sidebars;
the toe-piece has an overall length of at least twenty cm.

9. As in claim 1, wherein the sidebars of the toe-piece are of rectangular cross-section, having a height equal to the thickness of the fork, and having a thickness that is half the thickness of the fork, or less.

10. As in claim 1, wherein:
providing a second loadcell in the heel-piece of the fork, arranged so as to share the weight of the load;
the second loadcell includes a second flexure-member, having a second heel-end which is unitary with the heel-piece, and having a second cover-end which is unitary with the cover;
so arranging the second flexure-member as to undergo deflection of the second cover-end relative to the second heel-end, proportional to the load;
the loadcell includes a second strain-gauge, which measures the deflection of the second flexure-member under load, and transmits a proportionate signal to a receiver.

11. As in claim 3, wherein the toe-piece and the heel-piece are from one and the same fork.

12. Procedure for manufacturing a fork for a fork-lift-truck, in combination with an apparatus for measuring the weight of a load supported by the fork, including:
where a main-body of the fork includes a toe-end and a heel-end, a top surface and a bottom surface;
using a cutting machine to cut a pathway of width-W through the fork;
where the machine includes a cutting-head, and includes structure for moving the cutting-head relatively to the fork;
so applying the cutting-head to the fork that the pathway extends from the top-surface of the fork right through to the bottom surface;
so moving the cutting-head relative to the fork that the pathway has the shape of an elongated-U, in that the pathway comprises a width-path linking two length-paths;
where the two length-paths terminate in blind-ends;
so cutting the U-shaped pathway as to create a peninsula between the length-paths, in which:
(a) the peninsular is cantilevered out from a cantilever-root area of the main-body; and
(b) the main-body, including the peninsula and the cantilever-root area, is monolithic;
so arranging the apparatus that, upon a load being supported by the fork, the weight of the load rests on the distal-end of the peninsula, whereby the peninsula undergoes load-induced deflection relative to the main-body;
creating a loadcell by mounting a strain-gauge on a surface of the peninsula, whereby the strain-gauge measures the deflection of the peninsula under load, and transmits a proportionate signal to a receiver;
whereby the peninsula serves as flexure-member of the loadcell.

13. As in claim 12, wherein:
the cutting machine is an abrasive waterjet cutting machine, which cuts a pathway in the fork;
the cutting-head includes a waterjet, in which abrasive particles are entrained;
the machine includes structure for moving the cutting-head relatively to the fork.

14. As in claim 12, including:
providing a cover, and so arranging the apparatus that the weight of a load resting on the cover is transmitted down from the cover to the distal-end of the peninsula, through the peninsula, and down through the cantilever-root-area to the main-body of the fork;
so arranging the apparatus that the cover-assembly, at least during operation to measure the weight of the load, remains out of contact with the main-body of the fork;
being such contact that enables some of the weight of the load to be supported by the contact, rather than by the peninsula.

15. As in claim 14, including:
providing a second loadcell, and
so arranging the loadcells that the cover is supported by both loadcells and the weight of the load is divided between the loadcells.

16. As in claim 12, including so moving the cutting-head:
(a) that the left and right length-paths are straight and parallel, and are symmetrical about the axis of the fork; and
(b) as to form rounded corners at the junctions between the cross-path and the left and right length-paths.

17. As in claim 12, including:
insofar as the distance apart of the left and right length-paths varies along the length of the peninsula, the smallest distance apart is PDmin millimetres;
at or near the distal end of the peninsula, the maximum distance apart of the length-paths is PDmin×1.5, or greater.

18. As in claim 12, including so moving the cutting head that:
(a) the width of the peninsula is between 10% and 40% of the width or breadth of the fork;
(b) the depth or height of the peninsular is equal to the thickness of the fork.

19. As in claim 12, including so moving the cutting head that the two length-paths of the pathway are aligned lengthways in the fork, and symmetrically in the middle of the width of the fork.

20. As in claim 12, wherein:
where the peninsula has a length-L, a breadth-B, and a height-H;
the length-L is the length as measured from the cantilever-root-area to the distal-end of the peninsula;
insofar as the breadth of the peninsula varies along the length of the peninsula, the breadth-B is the smallest breadth;
insofar as the height of the peninsula varies along the length of the peninsula, the height-H is the smallest height;
the length-L of the cantilever equals the sum of the breadth-B and the height-H, or is greater; and
the length-L is ten cm or longer.

21. As in claim 12, including:
so moving the cutting head relative to the main-body as to create a second U-shaped pathway in the heel-piece, and thereby a second peninsula;
forming a second loadcell from the second peninsula;
where the loadcell and the second loadcell are located one near the toe-end of the heel-piece, and the other near the heel-end of the heel-piece;
so arranging the apparatus that the weight of the load is supported on both loadcells.

22. A fork for a fork-lift-truck, in combination with an apparatus for measuring a load supported by the fork, wherein the combination has been manufactured in a manner that embodies claim 12.
